(19) United States
(12) Patent Application Publication
(10) Pub. No.: US 2025/0180523 A1
(43) Pub. Date: Jun. 5, 2025

(54) SENSING SYSTEM FOR COOKING CONTENT AND METHOD FOR SENSING COOKING CONTENT

(71) Applicant: One Hearth Inc., Sunnyvale, CA (US)

(72) Inventors: Peng Chau Quah, Kirkland, WA (US); Gregory Russ Goddard, Carmel, IN (US); Michael Hanuschik, Sunnyvale, CA (US)

(21) Appl. No.: 18/962,048

(22) Filed: Nov. 27, 2024

Related U.S. Application Data
(60) Provisional application No. 63/604,771, filed on Nov. 30, 2023.

(51) Int. Cl. G01N 29/44; G01G 19/52; G01K 7/04; G01N 29/24; G01N 29/46

(52) U.S. Cl. CPC G01N 29/4427; G01G 19/52; G01K 7/04; G01N 29/2437; G01N 29/46

(57) ABSTRACT

A sensing system for cooking content includes at least one sensor and one or more processors. The at least one sensor is configured to sense an acoustic response of a cooking content in a cooking vessel. One or more processors being configured to transform the acoustic response to a frequency band, compare the frequency band with a cooking state database so as to correlate to a corresponding kind of the cooking content, analyze a wavelength distribution of the frequency band to correlate to a wavelength level; and determine a state of the cooking content by correlating the wavelength level with a corresponding waveform of the cooking state database. A method for sensing cooking content is also provided by the present disclosure.

### CROSS-REFERENCE TO RELATED PATENT APPLICATION

This application claims the benefit of priority to the U.S. Provisional Patent Application Ser. No. 63/604,771 entitled SENSING SYSTEM FOR COOKWARE AND COOKWARE CONTENT, filed on Nov. 30, 2023, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a sensing system for cooking content and a method for sensing the cooking content, and more particularly to a sensing system which can be used in an induction cooktops or ranges for sensing different states of food in the cookware.

### BACKGROUND OF THE DISCLOSURE

Cooking is a complex process that involves a large number of variables and dependencies to consider and keep track of in order to achieve a desired cooking result. Thus, it can be challenging to have insight into, and control of, the cooking process.

### SUMMARY OF THE DISCLOSURE

In response to the above-referenced technical inadequacies, the present disclosure provides a sensing system for cooking content.

In order to solve the above-mentioned problems, one of the technical aspects adopted by the present disclosure is to provide a sensing system for cooking content, which includes at least one sensor configured to sense an acoustic response of a cooking content in a cooking vessel; and one or more processors being configured to transform the acoustic response to a frequency band, compare the frequency band with a cooking state database so as to correlate to a corresponding kind of the cooking content, analyze a wavelength distribution of the frequency band to correlate to a wavelength level; and determine a state of the cooking content by correlating the wavelength level with a corresponding waveform of the cooking state database.

In order to solve the above-mentioned problems, another one of the technical aspects adopted by the present disclosure is to provide a method for sensing cooking content, which comprises: sensing an acoustic response of the cooking content; transforming the acoustic response to a frequency band; comparing the frequency band with a cooking state database so as to correlate to a corresponding kind of the cooking content; analyzing a wavelength distribution of the frequency band to correlate to a wavelength level; and determining a state of the cooking content by correlating the wavelength level with a corresponding waveform of the cooking state database.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The described embodiments may be better understood by reference to the following description and the accompanying drawings, in which:

FIG. 1 is an embodiment of an induction cooking device according to the present disclosure;

FIG. 2 is a schematic circuit diagram of an induction cooking system control architecture according to the present disclosure;

FIG. 3 is an acoustic sensing in an intelligent cooking system according to the present disclosure;

FIG. 4A is a an embodiment of passive sound sensing of the state of food being cooked in a cooking vessel according to the present disclosure;

FIG. 4B is an embodiment of passive sound sensing of the state of food being cooked in a cooking vessel according to the present disclosure;

FIGS. 5A and 5B are an embodiment of acoustics-based detecting of states of frying an egg according to the present disclosure;

FIGS. 6A and 6B are an embodiment of acoustics-based detecting of states of pan-frying chicken according to the present disclosure;

FIGS. 7A and 7B are an embodiment of acoustics-based detecting of states of pan-frying tofu according to the present disclosure; and

FIGS. 8A and 8B are an embodiment of acoustics-based detecting of states of pan-frying onions according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the present disclosure may take, may be referred to as techniques. In general, the order of the steps of disclosed processes may be altered within the scope of the present disclosure. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the present disclosure is provided below along with accompanying figures that illustrate the principles of the present disclosure. The present disclosure is described in connection with such embodiments, but the present disclosure is not limited to any embodiment. The scope of the present disclosure is limited only by the claims and the present disclosure encompasses numerous alternatives, modifications and equivalents. Numerous specific details are set forth in the following description in order to provide a thorough understanding of the present disclosure. These details are provided for the purpose of example and the present disclosure may be practiced according to the claims without some or all of these specific details. For the purpose of clarity, technical material that is known in the technical fields related to the present disclosure has not been described in detail so that the present disclosure is not unnecessarily obscured.

The following are embodiments of an intelligent induction cooking system. Embodiments of the intelligent induction cooking system described herein provide an integrated cooking system that integrates induction heating, detection of cookware, sensor measurements, app control, etc. to optimize the cooking experience. For example, compared to existing cooking systems, embodiments of the integrated induction cooking system described herein provide an improved cooking user experience by integrating cookware detection to determine dynamic, contextual user interfaces (UIs) to provide users information and prompts (e.g., what type of cooking techniques are available, available results of the food being cooked, etc.) that adapt to the type of cookware being used. This includes generating user interfaces customized for the type of cookware that is detected as being present. As another example, the integrated system, by integrating cookware detection with various sensor measurements and induction coil control, provides closed loop temperature control that both accurately and efficiently modulates power delivery from the induction coil to the cookware to provide predictable and repeatable cooking results and user experiences.

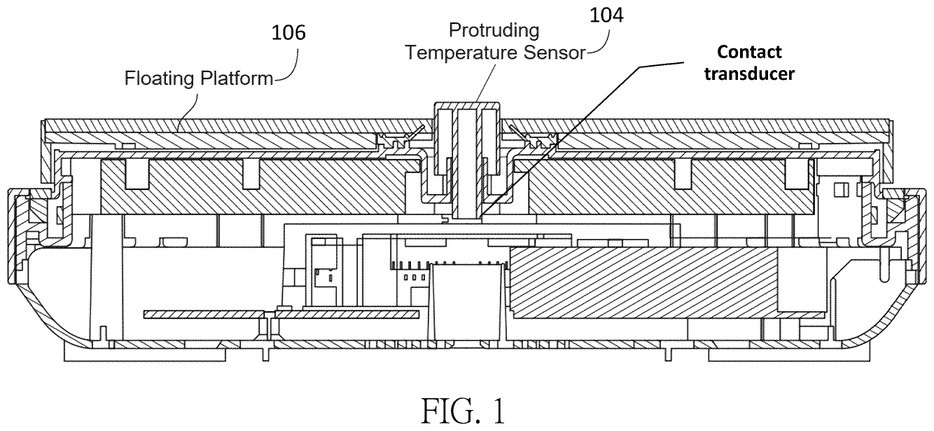

FIG. 1 illustrates an embodiment of an intelligent cooking device with a sensing system that includes contact acoustic sensors. In the example of FIG. 1, a cross-section of an intelligent induction cooking system is shown. The cooking device has a temperature sensor protruding through a moving or floating platform. In this example, protruding temperature sensor 104 is an example of temperature sensor.

In the example of FIG. 1 involving a floating platform 106, a spring-loaded mechanism is utilized for the protruding temperature sensor to ensure that the spring force of the temperature sensor does not affect weight measurements.

However, the aforementioned details are disclosed for exemplary purposes only, and are not meant to limit the scope of the present disclosure.

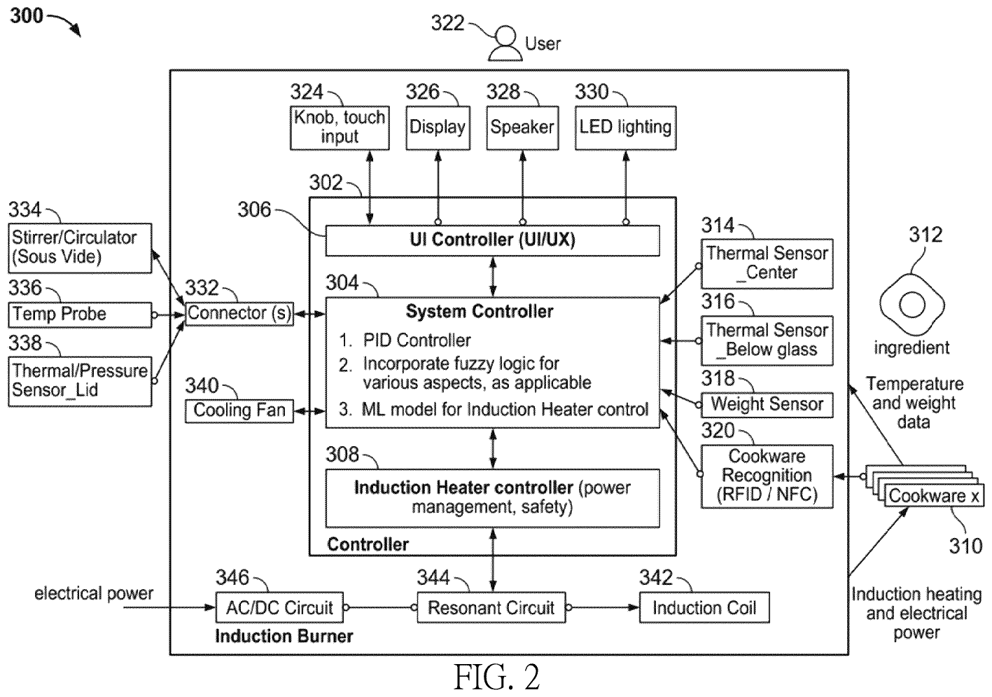

FIG. 2 illustrates an embodiment of an induction cooking system control architecture. In some embodiments, architecture 300 is an example of control architecture for controlling the components of sensing system and induction cooking device.

As shown in this example, the control architecture 300 includes controller 302. In this example, controller 302 further includes system controller 304, UI/UX controller 306, and induction heater controller 308.

In some embodiments, system controller 304 is configured to receive information from various components and interfaces and provide various commands to control hardware associated with the induction cooking system.

As one example, the system controller receives information and measurements from various sensors pertaining to the cookware (310) and ingredients (312) in the cookware, such as temperature and weight measurement data from temperature sensors, weight sensors, cookware detection sensors, etc. Examples of integrated temperature sensors include a thermal sensor 314 in the center of the top plate, such as temperature sensor 104. Another example sensor that the system controller receives temperature measurements from is one or more thermal sensors 316 that are below the top plate. The system also receives weight information from weight sensor 318. In some embodiments, measurements usable for cookware detection are received from cookware recognition sensors 320. Examples of such cookware recognition data include RFID (Radio Frequency Identification) data, NFC (Near Field Communication), etc. Cookware recognition can also be performed via signature identification using sensors of the system described herein. Further details regarding cookware recognition are described below.

In some embodiments, system controller 304 is configured to receive information from, and provide commands to UI (user interface)/UX (user experience) controller 306. For example, UI controller 306 is configured to receive information from, and/or provide information to various user interfaces via which user 322 interacts, such as a knob or touch input 324 (e.g., knob or touch screen of dial), display 326, audio speaker 328, and lighting ring 330.

In some embodiments, in addition to speaker(s) 328, the system also includes one or more microphones. In some embodiments, the microphones are used to facilitate voice control and voice command as an input. In some embodiments, the system responds with voice/audio feedback (e.g., via speakers integrated into the system, or via an external device such as a speaker or mobile device).

In some embodiments, the cooking device/induction stove is turned on by turning the dial or pressing on the dial, with visual (e.g., light ring) and audio (e.g., sound from the system, including cooling fan) feedback next to the active display of the intelligent dial to show various information such as the heat/temperature/power setting selected by the user. The system can be turned on whether or not cookware is in the presence of the system (e.g., on the top plate). This is similar to user experience of a gas stove, where the user can turn on the stove before or after placing the cookware.

In this example, the system controller further receives information from, and/or controls, components connected to the device (e.g., via connectors 332 such as USB-C connections, or as part of an integrated multi-cooker that is controllable by the system, or any other type of port, as appropriate). Examples of such connected components include stirrer/circulator 334 (e.g., used when performing sous vide), external temperature probe 336, external thermal/pressure sensor 338 (which, as one example, is part of a sensor of a multi-function cookware that is being utilized in conjunction with the induction cooking system). In some embodiments, power to a cookware device is provided via the induction coils, and/or a power connection such as USB-C. For example, a multi-cooker can be connected to and powered by the system. The cooking system also has control over the components of the multi-cooker.

In this example, the system controller is also configured to control cooling fan 340. This includes receiving fan information (e.g., fan speed), as well as providing controls (e.g., to adjust fan speed). In some embodiments, the system includes one or more fans to provide internal cooling. For example, fan 340 is a compact fan (e.g., laptop fan) that can be adjusted to perform various types of sound adjustment, such as noise cancelling, creation of desirable acoustics, etc. For example, the fan can be controlled by the system controller to suppress certain acoustic frequencies, as well as enhance certain frequencies to create an appropriate sound level and quality. In some embodiments, the system uses the noise level of the fan (e.g., as measured by a microphone integrated in the system) as acoustic feedback on the power level of the system. The system may include multiple fans, such as fans for cooling the power supply, fans for cooling the induction coil 342, etc.

The following are further embodiments of noise cancelling (e.g., cancelling of fan and all other sources of noise in the system). For example, as described above, certain acoustic frequencies can be suppressed or enhanced to create the appropriate sound level and quality. In some embodiments, the noise level is used as acoustic feedback on power level. Multiple fans may be used for cooling, where noise cancelling may be implemented on the fans to create desired sounds. As another example, the fan can be controlled to optimize the sound that is generated to emulate the sound of cooking with a gas stove. As one example, the sound of cooking with gas is characterized (e.g., as (1) Brown noise-spectral density drops 6 dB per octave, and (2) Gray noise-white noise (all frequencies randomly) convolved with A-weighting of human ear perception). The electronic noise and harmonics of the induction system are characterized. The system performs optimization (e.g., component selection, control algorithm changes, air flow optimization of the cooling fan) in order for the sound being generated by the induction cooking system (e.g., as characterized by amplitudes as a function of frequency) to emulate the profile of a gas stove (e.g., to emulate higher pitch “whistling” sounds in typical gas stoves).

The following are further embodiments of heating control. As one example, the heating control is implemented by system controller 304. For example, as described above, system controller 304 is configured to collect various sensor measurements, such as temperature, weight, induction power being delivered, etc. The system controller then processes the information and uses it (e.g., as feedback) to determine how to control the cooking process.

In some embodiments, the system measures temperature of the cookware, including rate of change of temperature. In some embodiments, the system measures weight of the cookware and the cooking content therein, including changes and rate of change (e.g., due to liquids evaporating, the addition of ingredients, etc.). Examples of weight sensors include load cells and strain gauges, which may be placed below the top plate or under the appliance. In some embodiments, the system measures the level of induction power being delivered to the cookware, including the rate of change in power. In some embodiments, measurement of temperature of ingredients is performed with a probe.

In some embodiments, based on all the input and output information, the system predicts the state (e.g., temperature, pressure, moisture, doneness, crispness, etc.) of the ingredients in the cookware. For example, a closed-loop control algorithm takes into account all the sensor data input, user input, derived cookware or foodstuffs state, etc., modulates the power delivery to the cookware, and delivers predictable and repeatable cooking results and user experience.

Various types of measurement data can be recorded and collected through various onboard sensors, such as temperature, weight, acoustics, induction, etc. Various different applications or insights are determined from the raw sensor data/measurements. In some embodiments, the derivation of the applications/insights from the raw sensor data is customized to a specific type of cookware. Raw sensor measurements from various sensors, such as acoustic sensors (which can include transducers, microphones in contact with the cookware, microphones that are air-coupled with the cookware, etc.), weight sensors, temperature sensors, etc. are synthesized together to determine various fingerprints or signatures or patterns of sensor measurements indicating certain cooking states or events. Contextual decisions are then made off the detected cooking states or events based on synthesizing sensor readings.

The center temperature contact (temperature contact probe 104 that is in contact with the cookware) is used to determine cookware temperature, cooking stage, etc.

The cooking system described herein includes an acoustic sensing system that utilizes acoustic sensors for facilitating various cooking intelligence, such as identifying cookware, cookware content, and cookware content state detection (e.g., of state of ingredients being cooked in cookware).

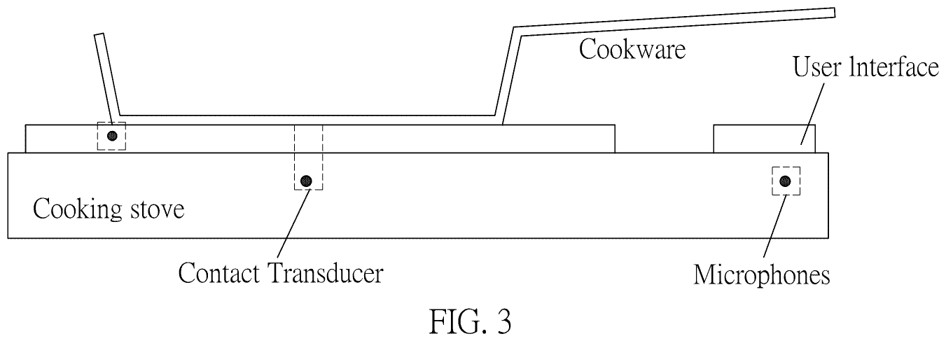

In some embodiments, the sensing system includes one or more acoustic sensors that are located or positioned at various parts of the cooking system to facilitate the acoustic sensing described herein. The acoustic sensors include air-coupled acoustic sensors. Referring to FIGS. 2 and 3, one example type of acoustic sensor is a microphone.

In some embodiments, acoustic sensors also include acoustic sensors that come in contact with cookware or cooking vessels. The use of acoustic sensors that are in contact with cookware is referred to herein as contact acoustics. Acoustic sensing using sensors that are in contact with cookware (e.g., at the bottom of the cookware, at the handle, connected to a structure that will be in direct contact with the bottom of a cooking vessel, or any other location as appropriate) improves sensing accuracy (e.g., sensing of various frequencies in acoustic response). Examples of contact acoustic sensors include transducers, such as piezoelectric elements/transducers. Piezoelectric transducers convert varying or oscillating electrical energy (e.g., AC power) into mechanical vibrations that can be transmitted. Piezoelectric Acoustics transducers also convert mechanical vibrations into an oscillating electrical signal that can be detected (e.g., AC signal). Piezoelectric transducers achieve this through the piezoelectric effect.

In some embodiments, multiple transducers and microphones are used to improve acoustic sensing, where such an array of combined acoustic sensor types is used to detect signal phase or time delay. In some embodiments, such information is used to provide, for example, localization of sound origin. The array of acoustic sensors can be expanded with contact transducers that are beneath the top plate.

The following are embodiments of passive sound sensing of the state of ingredients or content being cooked. In some embodiments, passive acoustic sensing is used to detect the cooking state of food in a cooking vessel (e.g., pan, pot, etc.). For example, emitted sounds arise from the sound of water evaporation, and changing acoustic properties of the ingredients (including size, denaturation, browning, etc.). Such characteristics, if identified, facilitate the quantification of cooking state. The quantification and classification of cooking state can then be used to facilitate cooking intelligence, such as triggering of the cooking device described herein to adapt the applied cooking power to achieve a perfect final cooked state (e.g., caramelized onions, seared tuna with rare interior, perfect hard-crack sugar syrup, etc.).

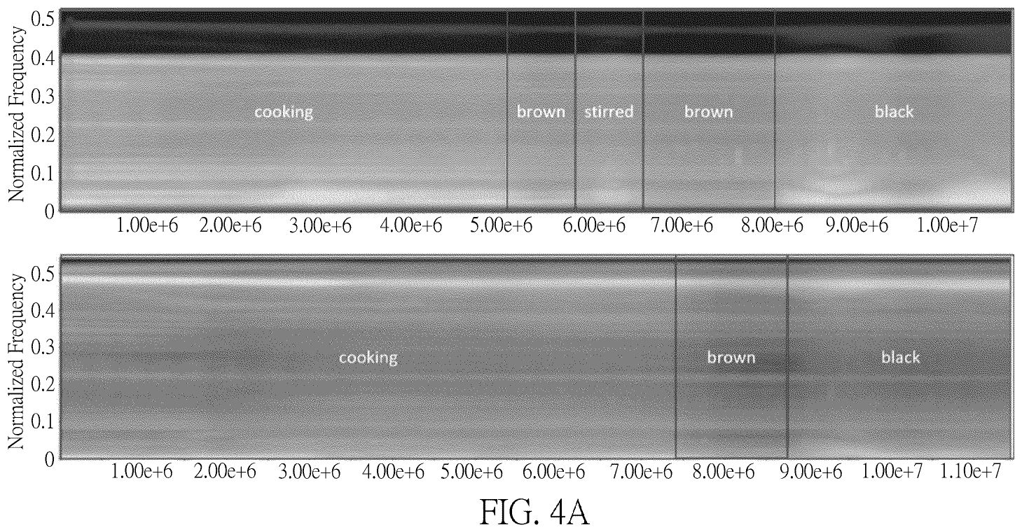

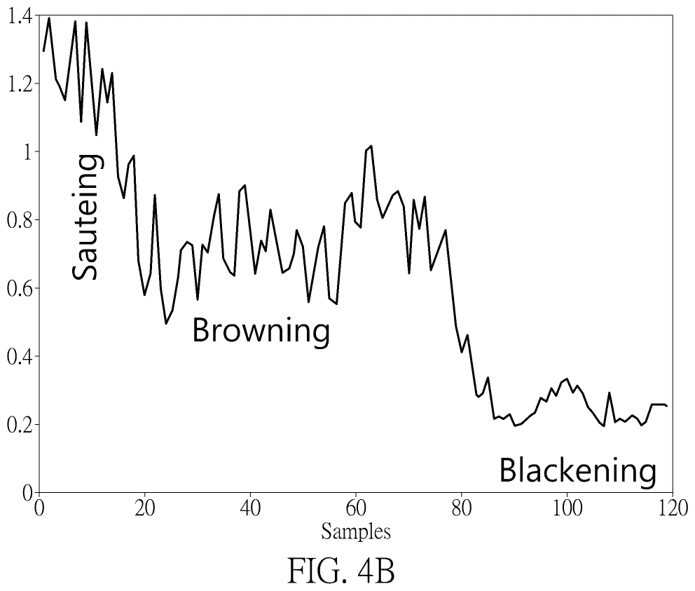

Referring to FIG. 4A, in this example, detection of various states of cooking of onions, as well as human interventions, are shown from analysis of the frequency response of cooking vessel signals detected by acoustic sensors.

FIG. 4B illustrates an embodiment of passive sound sensing of the state of food being cooked in a cooking vessel. A signal or frequency of the sensed acoustic spectra at 10 kHz is shown in this example.

The following are further embodiments of ingredient state/cooking phase/user intervention detection using contact acoustics (e.g., acoustic transducer directly coupled to the cooking vessel). In some embodiments, the state of the ingredient will change over the course of the cooking process. The changes in the state of the ingredient are indicative of what phase of the cooking process the ingredient is in. For example, in the process of pan frying a protein such as chicken, the chicken (ingredient) will, over time, progress from becoming browned, and potentially to be being blackened. As another example, boiling of water in a pressure pot can be considered as a process in which water is an ingredient that is being cooked. The boiling process for water during pressure pot cooking has various stages as well, such as steam escaping, rolling boiling, etc.

A frequency spectrum analysis of the resulting electrical signal is performed. The amplitude/magnitude of certain select frequencies is evaluated or monitored over time (over the time of the cooking process). For example, changes in the amplitudes of certain frequencies are indicative of a cooking state or ingredient state being entered or left. Further, one or more processors includes a Fast Fourier Transform chip can be used to perform the transforming process of the frequency spectrum.

As one example, consider browning. Browning is a consequence of the removal of water (due to heating) from an ingredient being cooked. When there is still water in an ingredient such as a protein (e.g., chicken), the presence of water prevents the temperature of the ingredient from increasing above a certain point (e.g., the boiling point of water). When a layer of water evaporates, the temperature of the ingredient will be able to rise, and the ingredient begins browning. That is, the evaporation or vaporization of water is indicative of the ingredient entering the browning stage. In some embodiments, this water vaporization phenomenon is acoustically detectable by monitoring an appropriate frequency. For example, when a sudden drop in amplitude at 5.5 kHz is detected, this is indicative that the layer of water vapor between the ingredient and the cooking vessel has evaporated (where the vaporization results in explosive effects that cause vibrations in the cooking vessel that are detected by the contact transducer), where the ingredient will then begin to brown.

Cooking processes can also involve user interventions, such as flipping of ingredients. In some embodiments, such user interventions are also identified from frequency analysis of sensed acoustic spectra. For example, the addition of an ingredient such as chicken will cause a sudden increase in amplitude at the 5.5 kHz frequency, due to the water in the ingredient interacting with the heated cooking vessel and vaporizing, where the explosions due to the vaporization are acoustically detectable. As described above, when the layer of water has vaporized more completely, the amplitude at that frequency will drop, indicating that browning is starting.

Changes or deltas in amplitude of other select frequencies are correlated and mapped or otherwise correspond to or are indicative of changes in ingredient state. The changes in amplitude and magnitude of such frequencies are measured and monitored over time. That is, different ingredient states are identifiable via unique acoustic signatures, where the acoustic signatures for ingredient states involve corresponding changes in amplitude of certain frequencies over the time of the cooking process. In some embodiments, the acoustic sensing system listens or monitors for (the sequence of) changes in magnitude of select frequencies. The changes in magnitude are used as flags or triggers to detect that a certain state of the ingredient, cooking process, or user intervention has been entered or occurred.

When detecting browning acoustically, a relevant or representative sound of browning is the evaporation or vaporization of water vapor that is in the ingredient (and that forms a layer between the ingredient being heated, and the cooking vessel surface that the ingredient is on). For example, browning is a result of removal of water. For example, a layer of water prevents the ingredient from heating beyond water's boiling point. When the water vapor is gone, the temperature of the ingredient will increase, and the ingredient will be able to brown. That is, there is a correlation between water vapor, amount of water, and the browning effect.

The water vaporization can be tracked by tracking the magnitude or intensity of a particular corresponding frequency (e.g., 5.5 kHz). That is, by tracking the changes in magnitude of the 5.5 kHz component of the acoustic signal picked up by the transducer during cooking, water vaporization over time can be monitored, which in turn is indicative of browning level being detected. In some embodiments, by monitoring specific frequencies, such as the 5.5 kHz browning frequency, processing power is saved by not having to analyze the entire frequency spectrum of the signal generated by the transducer during listening (because many frequencies will not be relevant to detecting of ingredient state). Tracking of the state of water vapor is also efficient because all foods and ingredients contain some amount of water. By knowing the acoustic response with respect to water in various different forms, monitoring of browning or other effects can be performed for ingredients that contain water, which is a common element across most ingredients that are cooked.

The various states of the water over time, such as sizzling and boiling are evaluated at 5.5 kHz to observe that changes in magnitude at that frequency over time correspond to the vaporization of the water in the sponge.

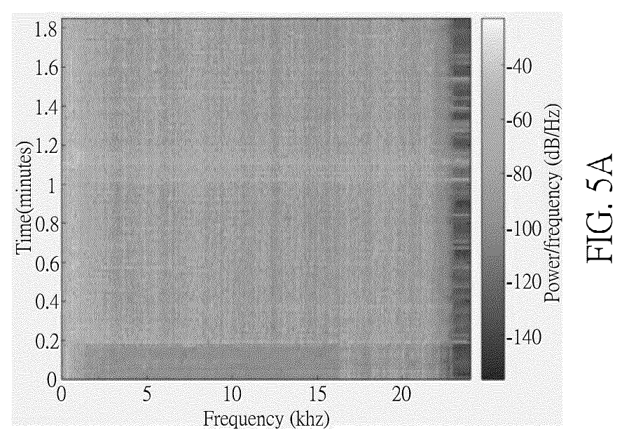

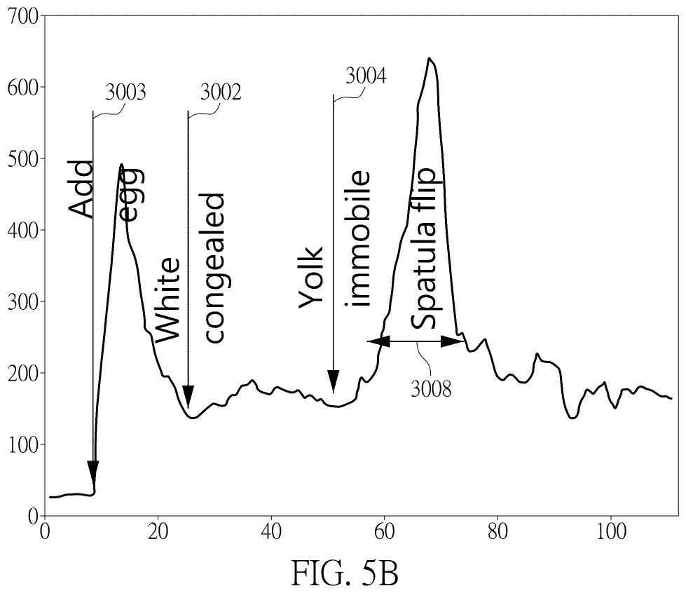

FIGS. 5A and 5B illustrate an embodiment of acoustics-based detecting of states of frying an egg. As shown in this example, eggs (ingredient) have a bimodal cooking behavior. For example, the egg sizzles initially. The white bottom surface congeals. There is a lower rumble corresponding to white thickness cooking. FIG. 5B illustrates an embodiment of a spectrogram of acoustic measurements over time when cooking an ingredient such as an egg. The spectrogram visually represents the spectrum of frequencies of the signal measured by the transducer, as it varies over time. FIG. 5A illustrates an embodiment of the amplitude or intensity of a particular select frequency over time. In this example, the amplitude of the 5.5 kHz frequency component over time is shown. As shown in this example, there are various peaks and valleys in the amplitude of the 5.5 kHz frequency component in the sensed acoustic measurements from the pickup transducer. The peaks and valleys in amplitude correspond to changes in magnitude of the frequency component over time. In this example, the peaks and valleys, over time, are indicative of different stages of frying an egg, including the state of the egg (e.g., white congealing (3002), immobile yolk (3004), etc.), as well as user interventions (e.g., adding the egg (3006), flipping a spatula (3008), etc.).

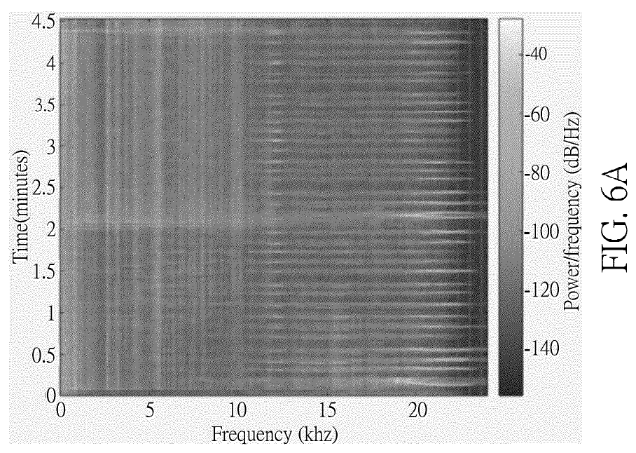

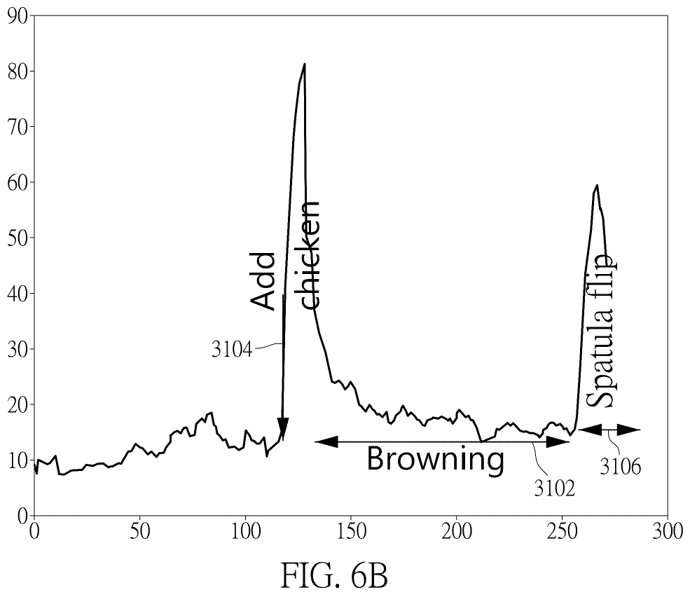

FIGS. 6A and 6B illustrate an embodiment of acoustics-based detecting of states of pan-frying chicken. FIG. 6A shows an example of the intensity of the 5.5 KHz frequency component over time. The 5.5 KHz frequency component is monitored over time, as changes in the 5.5 kHz component (which are a result of phenomena occurring with respect to the water in the chicken) correspond to changes in the state of the chicken. As shown in this example, chicken has exponential decay as water evaporates and the bottom of the chicken browns (3102). User interventions/events such as adding of the chicken (3104) and spatula flipping (3106) are also detected based on change in magnitude of the frequency component. FIG. 6B shows an example spectrogram over the course of the pan-frying of chicken.

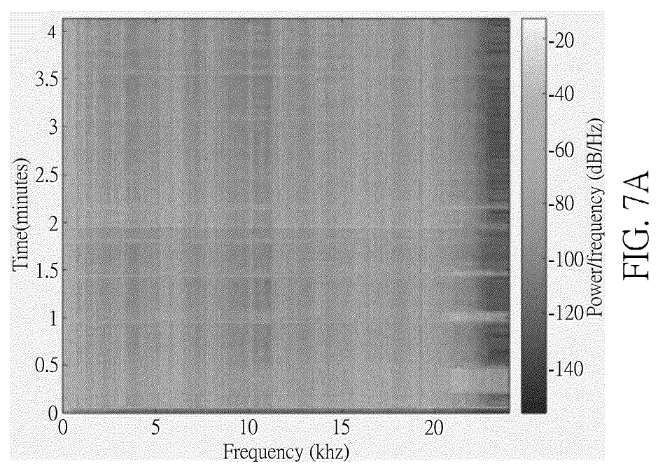

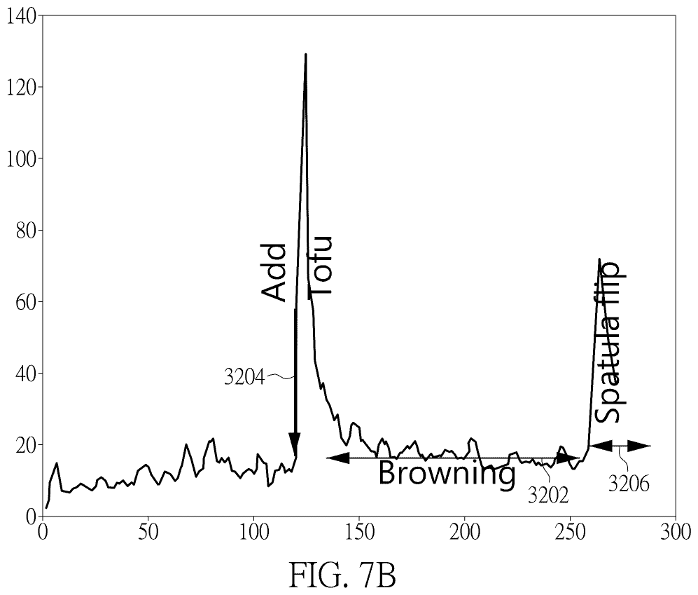

FIGS. 7A and 7B illustrate an embodiment of acoustics-based detecting of states of pan-frying tofu. FIG. 7A shows an example of the intensity of a select frequency component that is monitored over time to detect browning of the ingredient (tofu in this example). For example, the 5.5 kHz frequency is monitored. As shown in this example of FIG. 7A, pan-frying of tofu as a similar amplitude profile over time as pan-frying of chicken (as shown in the example of FIG. 7A). For example, tofu also has an exponential decay as water evaporates and the bottom of the tofu browns (3202). User interventions/events such as adding of the tofu (3204) and spatula flipping (3206) are also detected. A spectrogram of the process of pan-frying tofu is shown in the example of FIG. 7B.

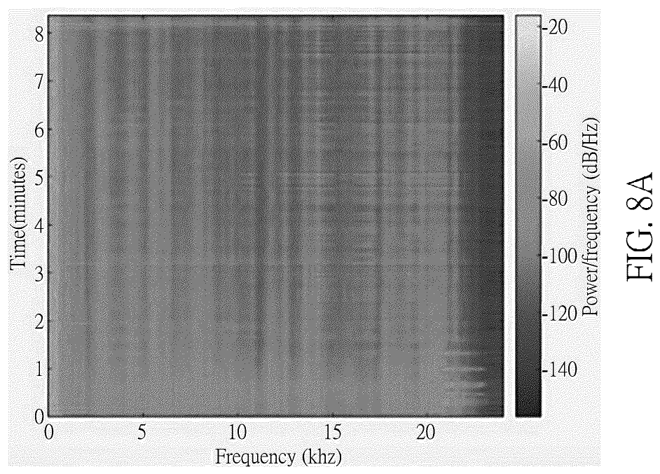

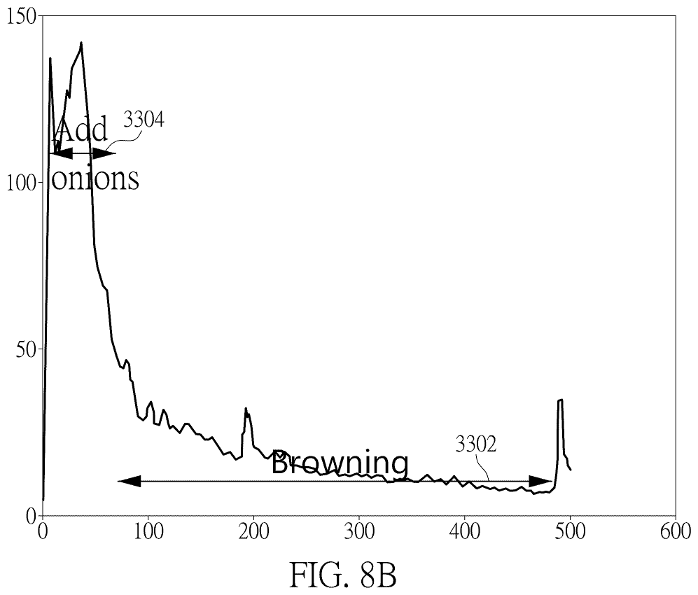

FIGS. 8A and 8B illustrate an embodiment of acoustics-based detecting of states of pan-frying onions. FIG. 8A shows an example of the intensity or magnitude of a select frequency component that is monitored over time to detect browning of the ingredient (onions in this example). For example, the 5.5 kHz frequency is monitored. While there are several “pops” or peaks in the amplitude of the 5.5 kHz component, corresponding to onions jumping on the pan, pan-frying of onions generally exhibits an exponential decay as water evaporates and the bottom browns (3302). A user intervention of adding the onions is also detected at 3304. A spectrogram of the process of pan-frying onions is shown in the example of FIG. 8B.

In some embodiments, control of the intelligent cooking system described herein can be adjusted based on the acoustics-based detection of browning level. For example, the induction coil or heating element can be controlled to control the temperature of the cooking vessel for browning.

In addition to monitoring the 5.5 kHz band to listen to water vapor as an indication of browning of ingredients, other frequencies correlated to or representative of other ingredient states can also be monitored. For example, the occurrence of blackening (and burning) of food when being heated is correlated with a low frequency, such as ˜500 Hz (0.5 kHz). For example, if the amplitude of the 0.5 kHz frequency of the acoustically sensed signal (that is generated in response to acoustically sensing the cooking vessel) increases, then this is indicative of the ingredient burning. For example, when food burns, a sort of “tar” is formed in the presence of fat and hydrocarbons burning at a certain temperature for too long. This results in a change in density of the ingredient that is in contact with the cooking vessel (or with a tar-like consistency, may attach to the pan, dampening its ability to vibrate), which in turn affects how the cooking vessel vibrates. This change in the cooking vessel vibration due to blackening corresponds to an increase in the amplitude of the lower frequency 0.5 kHz component detectable in the signal that is generated based on acoustic sensing. Thus, by monitoring different frequencies, browning and blackening can be acoustically distinguished and monitored for.

There are various types of boiling of water, such as slow simmering, simmering, rolling boil, etc. In some embodiments, changes in amplitude of specific frequency components of a measurement signal that is based on acoustic sensing of the cooking vessel are monitored to detect changes in magnitude over time that correlate to the various types of boiling.

As one example, changes in amplitude of the 400 Hz component of the acoustic measurement signal (e.g., generated by a contact transducer in direct contact with the cooking vessel) are correlated with different types or stages or degrees of boiling.

As shown in the examples above, the state of ingredients can be identified from detecting correlated or corresponding acoustic signatures in the spectra of what is acoustically sensed by a transducer that is coupled to a cooking vessel in which the ingredients are being cooked. This includes monitoring a set of frequencies, where changes in the amplitudes of the monitored frequencies over time are correlated or mapped to ingredient state, user interventions, etc. In the above examples, the intensity of specific frequency components at 400 Hz, 500 Hz, and 5.5 kHz were monitored over time to detect different types of ingredient states. In some embodiments, a band about monitored frequencies is passed for evaluation (e.g., 200 Hz band around a frequency component). In some embodiments, the selected individual frequency components/bands are extracted or isolated using an FFT (Fast Fourier Transform) program in a chip or a device. As another example, the detection circuit coupled to the transducer includes multiple receivers, each configured to detect one of the bands of interest (e.g., through the use of filters).

In addition, a cooking state database can be established in a data storage device that includes a cooking content-and-state table recorded with different states of the cooking contents. The one or more processors are configured to analyze the wavelength distribution of the frequency band based on a regression equation, and determine the state of the cooking content to match up with the cooking content-and-state table.

As described above, certain frequencies in the signal that is based on acoustic sensing are monitored for over time, where changes in magnitude of those frequencies are used as flags or triggers to indicate to the logic of the intelligent cooking system logic that a certain ingredient state has been detected or entered. In some embodiments, what frequencies to monitor for are determined based on cooking mode. Further, the type of event or classification of ingredient state that is to be monitored for and/or detected is based on the cooking mode.

As one example, a subset of the candidate/available frequencies that can be listened to is selected based on the cooking mode that is currently being utilized. Suppose, for example, that the system maintains mappings for five different bands, each corresponding to detection of a type of ingredient state and/or user intervention. Suppose that of the five, only three are relevant to pressure cooking. In this example, based on the cooking mode or technique that is selected, only the frequency bands that are relevant to the cooking mode are monitored. This provides more efficient performance (by reducing computational load), as not all possible bands need be monitored. For example, when in pan frying mode, the 5.5 kHz band is listened to for browning, and the 500 Hz band is listened to for blackening. When in pressure-cooker mode, the 400 Hz band is listened to (but the 5.5 kHz and 500 Hz bands need not be). In some embodiments, the type of ingredient state classifications that are made based on acoustic sensing are also based on the cooking mode. For example, the pan-frying mode is associated with a certain set of possible states, while the pressure-cooking mode is associated with its own respective set of possible states that is different from that of the pan-frying mode.

In some embodiments, frequencies of interest that are correlated to phase changes (of ingredients) are determined by performing a test type of cooking, acoustically monitoring the cooking over time with a contact transducer, and determining the spectrogram for the sensor readings/measurement signal from the contact transducer. The spectrogram plots intensity of frequency components in the spectra of the measured signal over time. Frequencies with changes in intensity or other activity in the frequency domain that correlate to phase changes in ingredients in time (e.g., via matching of timestamps between what is occurring in the spectra outputted by the contact acoustics sensor and what is observed over the course of cooking) are identified as frequencies of interest that are usable as signatures to determine ingredient state/phase changes. Analyses such as FFTs can then be performed to single out individual frequencies for further analysis and testing. In some embodiments, frequencies of interest are identified as those whose changes in magnitude correlate to sub-components that are common across or within a large number of ingredients. As described above, water is one such example. In some embodiments, water is subjected to various types of scenarios (e.g., pan frying, pressure cooking, hot plates, etc.), where the acoustic response of water under the various situations is characterized to identify signatures or features in the spectra of the acoustic response that correlate to ingredient state, cooking phenomena, etc.

While acoustic ingredient state detection has been described in the context of induction coil heating for illustrative purposes, in various embodiments the acoustic ingredient state detection techniques described herein may be variously adapted to accommodate other types of heating elements, such as gas stoves, electric stoves, ovens, etc. The techniques described herein for listening to the cooking of ingredients can be performed in various other contexts other than induction cooking, such as in an oven (e.g., radiative, convective from gas/electric/microwave, etc.). While acoustic sensing using contact transducers has been described herein for illustrative purposes, other types of acoustic sensors may be utilized. Air-coupled sensors may also be used to perform the ingredient state detection.

The measured acoustic spectra can be combined with other sensor measurements to further improve the classification of ingredient state. For example, sensor fusion can be used to integrate contact acoustics measurements, camera measurements, etc. to improve the fidelity of the estimation of ingredient state. As one example, weight and temperature measurements can be combined with acoustic sensor measurements to further improve the confidence of the ingredient state/phase determination. For example, suppose that the monitoring system is determining whether vigorous boiling is occurring or blackening is occurring. Vigorous boiling coincides with a large weight change, while blackening does not. If a weight change is determined to be occurring at the time of interest, then it is determined that it is more likely that vigorous boiling has occurred. That is, further sensor information can be used to augment the acoustic sensor measurements to identify the ingredient state.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A sensing system for cooking content, comprising:
at least one sensor configured to sense an acoustic response of a cooking content in a cooking vessel; and
one or more processors being configured to:
transform the acoustic response to a frequency band;
compare the frequency band with a cooking state database so as to correlate to a corresponding kind of the cooking content;
analyze a wavelength distribution of the frequency band to correlate to a wavelength level; and
determine a state of the cooking content by correlating the wavelength level with a corresponding waveform of the cooking state database.

2. The sensing system for cooking content of claim 1, wherein the one or more processors comprising a Fast Fourier Transform chip to perform the transforming process.

3. The sensing system for cooking content of claim 1, wherein the at least one sensor comprises an acoustic transducer.

4. The sensing system for cooking content of claim 3, wherein the acoustic transducer is in contact with the cooking vessel.

5. The sensing system for cooking content of claim 3, wherein the acoustic transducer comprises a piezoelectric transducer.

6. The sensing system for cooking content of claim 1, wherein the at least one sensor comprises a thermocouple.

7. The sensing system for cooking content of claim 1, further comprising a weighing device to contact the cooking vessel to sense a weight change of the cooking content.

8. The sensing system for cooking content of claim 1, further comprising a data storage device for storing the cooking state database.

9. The sensing system for cooking content of claim 1, wherein the cooking state database includes a plurality of cooking content kinds, and each of the cooking content kinds has a relative waveform that are divided into a plurality of cooking states corresponded to a plurality of recorded wavelengths.

10. The sensing system for cooking content of claim 1, wherein the cooking state database includes a cooking content-and-state table recorded with different states of the cooking contents, and the one or more processors are configured to analyze the wavelength distribution of the frequency band based on a regression equation, and determine the state of the cooking content to match up with the cooking content-and-state table.

11. A method for sensing cooking content, comprising:
sensing an acoustic response of the cooking content;
transforming the acoustic response to a frequency band;
comparing the frequency band with a cooking state database so as to correlate to a corresponding kind of the cooking content;
analyzing a wavelength distribution of the frequency band to correlate to a wavelength level; and
determining a state of the cooking content by correlating the wavelength level with a corresponding waveform of the cooking state database.

12. The method for sensing cooking content of claim 11, wherein the comparing process is performed by a method of Fast Fourier Transform.

13. The method for sensing cooking content of claim 11, further comprising a process of:
sensing a thermodynamic response of the cooking content; and
comparing the thermodynamic response with a temperature waveform graph of cooking contents.

14. The method for sensing cooking content of claim 11, further comprising a process of:
sensing a weight of the cooking content; and
comparing an initial weight of the cooking content.
